(19) United States
(12) Patent Application Publication
(10) Pub. No.: US 2026/0257813 A1
(43) Pub. Date: Sep. 3, 2026

(54) LAUNCH VEHICLE VENT SYSTEMS

(71) Applicant: BLUE ORIGIN, LLC, KENT, WA (US)

(72) Inventors: Alexander Troiani, Seattle, WA (US); Kevin Moran, Bonney Lake, WA (US); Kyle Meyer, South Hill, WA (US); Ryle Maxson, Bremerton, WA (US)

(21) Appl. No.: 18/952,848

(22) Filed: Nov. 19, 2024

(51) Int. Cl. B64G 1/40; B64G 1/00

(52) U.S. Cl. CPC B64G 1/4021; B64G 1/006

(57) ABSTRACT

A capping system may include a cap and an interface panel. The cap may be closed against the interface panel by a release mechanism and by a seal under preloaded stress state within the cap. The cap may be configured to be ejected along a trajectory or path which is away from a launch vehicle trajectory or path based in part on the release mechanism being disengaged and based in part on a seal being released from the preloaded stress state.

### FIELD

The present disclosure is generally related to capping systems and, more particularly, is directed to capping for ejection of a cap from a launch vehicle without damaging any aspect of the launch vehicle.

### BACKGROUND

A launch vehicle may include one or more modules that may be associated with capping systems. For example, a venting system of the launch vehicle may include a cap to be deployed by pyrotechnics. Pyrotechnics may result in shocks to potentially sensitive nearby equipment.

### SUMMARY

In some aspects, the disclosure herein includes a capping system for a launch vehicle having a cap and an interface panel. The cap can include a seal, a release hinge, and a first portion of release mechanism. The interface panel can include a lip, a latch, and a second portion of the release mechanism. When the cap is closed, the seal may be in a preloaded stress state against the lip, the release hinge may be within the latch, and the first portion of the release mechanism may be engaged with the second portion of the release mechanism. When the first portion of the release mechanism disengages from the second portion of the release mechanism, the seal may be released from the preloaded stress state, the release hinge may be released from the latch, and the cap may be ejected along a trajectory or path which may be away from a launch vehicle trajectory or path.

In other non-limiting aspects, the disclosure herein includes a propellant tank of a launch vehicle incorporating a capping system. The capping system may include a cap which may be closed against an interface panel by a release mechanism and by a seal under a preloaded stress state within the cap. The cap may be configured to be ejected along a trajectory or path which may be away from a launch vehicle trajectory or path based in part on the release mechanism being disengaged and based in part on a seal being released from the preloaded stress state.

In further non-limiting aspects, the disclosure herein includes a method associated with a capping system for a launch vehicle. The method may include associating a cap with a launch vehicle, the cap comprising a seal, a release hinge, and a first portion of release mechanism. The method may include associating an interface panel with the launch vehicle, the interface panel comprising a lip, a latch, and a second portion of the release mechanism. A step in the method may include closing the cap against the interface panel so that the seal is in a preloaded stress state against the lip, the release hinge is within the latch, and the first portion of the release mechanism is engaged with the second portion of the release mechanism. A further step may include allowing the first portion of the release mechanism to disengage from the second portion of the release mechanism so that the seal is released from the preloaded stress state, the release hinge is released from the latch, and the cap is ejected along a trajectory or path that is away from a launch vehicle trajectory or path.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a capping system that is closed, in accordance with at least one non-limiting aspect of the present disclosure;

FIG. 2 illustrates a capping system that is at least partly open, in accordance with a further non-limiting aspect of the present disclosure;

FIG. 3 illustrates exterior aspects of the capping system, in accordance with yet another non-limiting aspect of the present disclosure;

FIG. 4 illustrates interior aspects of the capping system, in accordance with yet another non-limiting aspect of the present disclosure;

FIG. 5 illustrates a capping system used with a venting system, in accordance with yet another non-limiting aspect of the present disclosure;

FIG. 6 illustrates part of space mission for a launch vehicle having a capping system, in accordance with yet another non-limiting aspect of the present disclosure;

FIG. 7 illustrates aspects associated with disengagement of caps to different trajectories or flight paths from a capping system in a launch vehicle, in accordance with yet another non-limiting aspect of the present disclosure; and

FIG. 8 illustrates a method for a capping system, in accordance with yet another non-limiting aspect of the present disclosure.

### DETAILED DESCRIPTION

A capping system may form a closure or a retention feature with respect to certain spaces within an overall system. For example, the capping system may ensure that an internal environment within an enclosed space, is retained from an external environment until the closure or retention feature is no longer required. The overall system may include propellant tanks, camera system, safety equipment, high pressure equipment, among other such structures. In the example, of a propellant tank, this may be a cylindrical structure which may be pressurized, may be temperature controlled, and may include at least one inlet and outlet feature. The propellant tank may be a cryogenic tank. The overall system may be a launch vehicle that may include the propellant tank as part of a propulsion or rocket module. The propellant tank of the launch vehicle may include a venting system that may be associated with the capping system. In the launch vehicle, a venting from a venting system may cause sideways thrust vectors for the launch vehicle. The capping system herein may be able to address this by ejecting a cap from the capping system to enable an opposite venting from a vent line, where the opposite venting can oppose or negate the sideways thrust vectors for the launch vehicle. In addition, the capping system can eject the cap in a manner that prevents or avoids damage to any part of the launch vehicle.

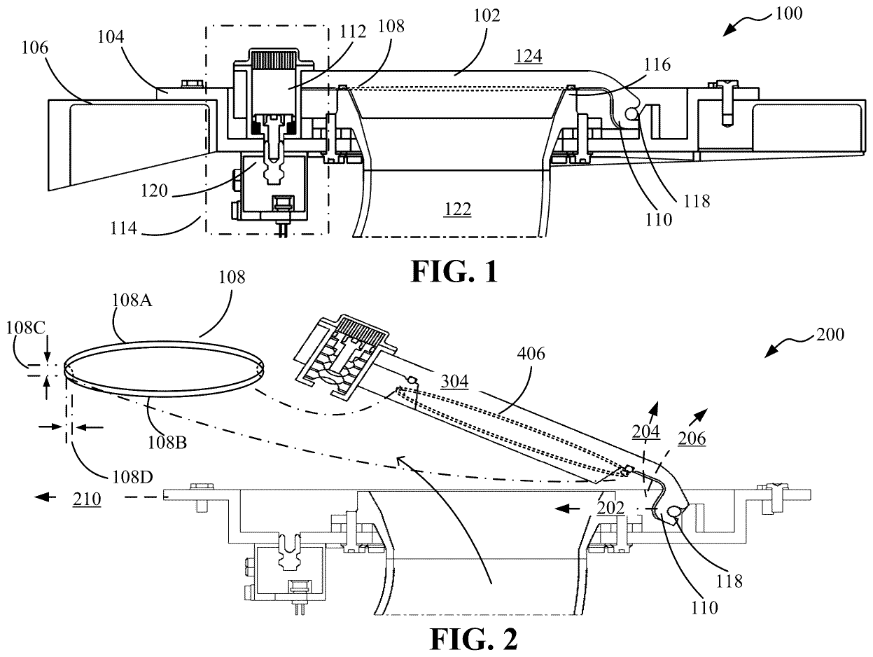

FIG. 1 illustrates a capping system 100 that is closed, in accordance with at least one non-limiting aspect of the present disclosure. The capping system 100 may be for a launch vehicle. The capping system 100 may include a cap 102 and an interface panel 104. The interface panel 104 may be part of a further feature 106 of an overall system, such as a body or a skirting of a launch vehicle. The cap 102 may include a seal 108, a release hinge 110, and a first portion 112 of a release mechanism 114.

The interface panel 104 may include a lip 116, a latch 118, and a second portion 120 of the release mechanism 114. When the cap 102 is closed, as illustrated, the seal 108 may be in a preloaded stress state against the lip 116. Further, when the cap 102 is closed, the release hinge 110 may be within the latch 118. Still further, when the cap 102 is closed, the first portion 112 of the release mechanism 114 may be engaged with the second portion 120 of the release mechanism 114. When closed, the capping system 100 may ensure that an internal environment 122, within a space being closed, is retained from an external environment 124 until the closure or retention feature is no longer required.

FIG. 2 illustrates a capping system 200 that is at least partly open, in accordance with a further non-limiting aspect of the present disclosure. The caping system 200 in FIG. 2 may be an open position view of the capping system 100 in FIG. 1. In the partly open state, the first portion 112 of the release mechanism 114 is disengaged from the second portion 120 of the release mechanism 114. The release hinge 110 may be associated with the latch 118 till an appropriate release angle 206 is reached. At the same time, the seal 108 may be released from the preloaded stress state it may have been under while in the closed position of the capping system 100, in FIG. 1. Therefore, although illustrated as partly open, the ejection of the cap 102 occurs almost instantaneously, with the release mechanism 114 disengaging, the seal 108 coming out of its preloaded stress state, and the release hinge 110 unlatching from the latch 118 occurring within fractions of a second.

In one example, the seal 108 may be in the preloaded stress state or may be energized against the lip 116 of the interface panel 104. The seal 108 may be a dual-surface annular seal having a top surface 108A, a bottom surface 108B, and a connected separation 108C that allows preloading thereof or energizing thereof. The connected separation 108C may be a C-shape, an S-shape, or other suitable shape member that connects together the top surface 108A and the bottom surface 108B of the annular seal. The preloading or energizing may cause deformation 108D of at least the connected separation 108C. The disengagement of the first portion 112 from the second portion 120 of the release mechanism 114 may allow the connected separation 108C to retain its deenergized or unloaded shape. In doing so, the release hinge 110 may be released from the latch 118. The cap 102 may be ejected along a trajectory or path that is away from a launch vehicle trajectory or path.

To enable the release of the release hinge 110, the release hinge 110 and the latch 118 may be releasably associated. This may also enable the vent cap to be closed and to be disengaged, with respect to at least the interface panel 104 of the capping system 100, 200. In one example, the release hinge 110 may be at a first angle 202 with respect to an axis 210 of the interface panel 104, when the cap 102 is closed. The release hinge 110 may be at least at a second angle 206 with respect to the interface panel 104 to enable being the cap to be ejected from the launch vehicle. The release hinge 110 may be at any intermediate angle 204 with respect to the interface panel 104, during which time, the cap may remain associated with the interface panel 104 and may not be ejected from the capping system. Therefore, in an aspect herein, it is possible to determine a length of engagement or a trajectory or path for one or more of the seal 108 or the cap 102 based in part on the release hinge 110 and the angle 202-206 enabled between the release hinge 110 and the latch 118.

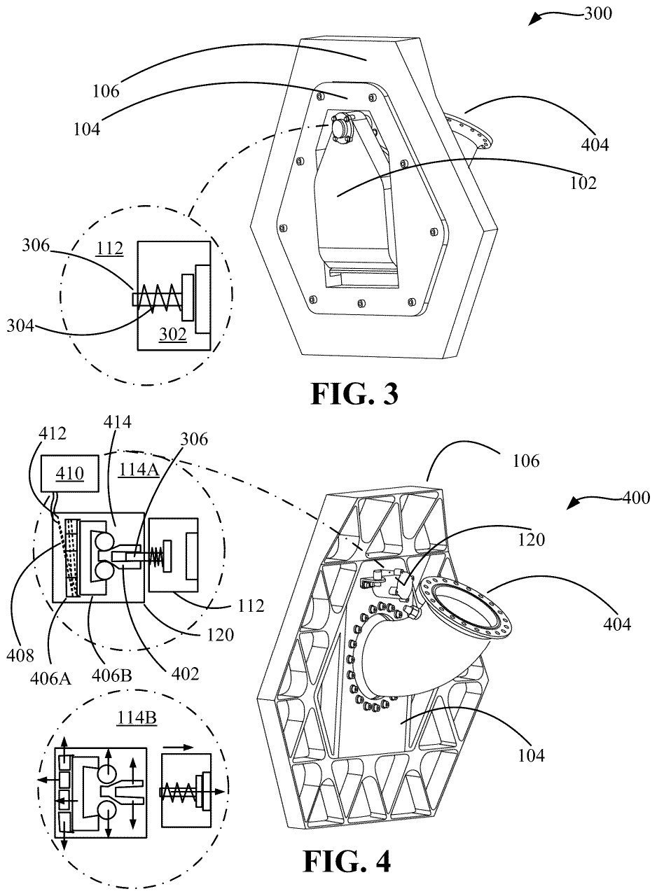

FIG. 3 illustrates exterior aspects 300 of the capping system, in accordance with yet another non-limiting aspect of the present disclosure. The exterior aspects 300 illustrate that a capping system 100 may include a cap 102 and an interface panel 104, where the interface panel 104 may be part of a further feature 106 of an overall system, such as a body or a skirting of a launch vehicle. FIG. 3 also illustrates that a first portion 112 of the release mechanism 114 may include a release rod chamber 302 and may include a spring 304 that may be associated with a release rod 306. The spring 304 may allow the release rod 306 to extend out from and to be captured by the release rod chamber 302. When extended, the release rod 306 may be engaged with a release tube 402, as illustrated in FIG. 4. When the release rod 306 is engaged with the release tube 402, the cap 102 may be closed with respect to the interface panel 104 having the second portion 120 of the release mechanism 114.

FIG. 4 illustrates interior aspects 400 of the capping system, in accordance with yet another non-limiting aspect of the present disclosure. The interior aspects 400 include an end 404 of a vent line which may be terminated by a cap 102 of the capping system 100, 200. The second portion 120 of the release mechanism 114 is illustrated in an engaged position 114A for the release mechanism 114 and in a disengaged position 114B for the release mechanism 114. In the engaged position 114A, the release rod 306 is illustrated as being extended from the release rod chamber 302 and firmly within the release tube 402. Therefore, the release rod 306 may be in an extended position. When the release rod 306 is back in the release rod chamber, as in the disengaged position 114B for the release mechanism, then the release rod 306 may be captured in the release rod chamber 302.

The interior aspects 400 also illustrate that when the release rod 306 is being held by a release tube 402, the release tube 402 is, in turn, held by ball bearing or other holding segments 406A, 406B. The other holding features would be appreciated upon review of this entire description pertaining to holding of a release rod 306 within a release tube 402 and supported by a fuse or fuse wire 408. As illustrated in the interior aspects 400, there may be an electrical circuit 410 to provide a trigger using electrical signals through an electrical or circuit line 412. The release mechanism 114 may be, therefore, associated with an electrical trigger that can cause a fuse or fuse wire 408, illustrated in part by the broken lines, to heat and to disintegrate.

The fuse or fuse wire 408 may hold together, directly or indirectly, the holding segments 406A, 406B till it disintegrates. Therefore, in one example, the release mechanism 114 herein is an electrical fuse-based release mechanism. Further, energizing or imparting a preloaded stress state to the seal may be enabled, at least in part, by engaging the cap 102 with the interface panel 104, which causes the two portions 112, 120 of the release mechanism 114 to engage so that the release rod 306 is extended from the release rod chamber 302 and is within the release tube chamber 414. When the fuse or fuse wire 408 disintegrates, the holding segments 406A, 406B open and release backward into a space available in the release tube chamber 414. The bearing balls or other holding segments 406A, 406B also release from their tightly packed position and allow the release tube 402 to release the release rod 306.

A spring action by the spring 304 of the release rod chamber 302 may cause the release rod 306 to be propelled into and to be captured by the release rod chamber 302. This is illustrated in the disengaged position 114B for the release mechanism 114 in FIG. 4. The release tube chamber 414 may be fixedly or removably associated with the interface panel 104, while the release rod chamber 302 may be fixedly or removably associated with the cap 102. The release of the release rod 306 may allow a cap 102 to be in an intermediate position, where a release hinge 110 may be at any intermediate angle 204 with respect to the interface panel 104. The cap 102 may not be separated or ejected from the interface panel 104 at the intermediate position. The cap 102 may be separated or ejected from the interface panel 104 once the release hinge 110 is at the second angle 206 with respect to the interface panel 104. While discussed as occurring over a period, the angles 202-206 discussed herein and the intermediate position may not be visibly apparent and the separation or ejection of a cap 102 from being closed may be instantaneous.

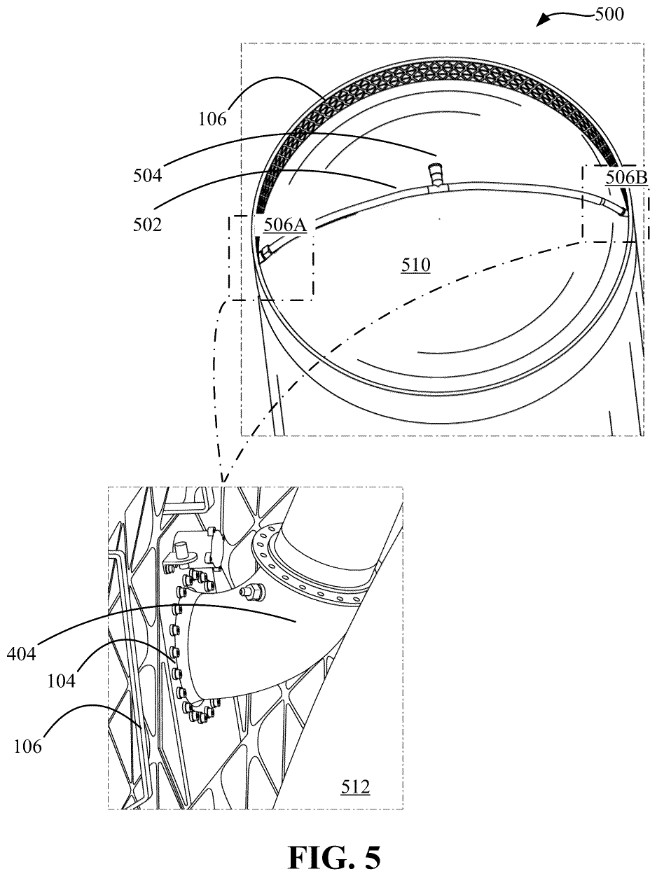

FIG. 5 illustrates a capping system used with a venting system 500, in accordance with yet another non-limiting aspect of the present disclosure. The venting system 500 may include a vent line 502 having an inlet 504 and one or more outlets 506A, 506B. The venting system 500 may be associated with a propellant tank 510 of a launch vehicle. The launch vehicle having the propellant tank 510 and the capping system 100, 200 at one or more of the outlets 506A, 506B may be able to support venting for the vent line 502 at one or more of the outlets 506A, 506B. In one example, the capping system 100, 200 may include the cap 102 which may be closed against an interface panel 104 by a release mechanism 114, as detailed with respect to at least FIGS. 1-4. The capping system 100, 200 may include a seal 108 that may be under a preloaded stress state within the cap 102. As illustrated in the callout 512 in FIG. 5, there may be multiple caps 102 subject to separation or ejection at different times. Each cap 102 may be configured to be ejected along a trajectory or path that is away from a launch vehicle trajectory or path based in part on the release mechanism 114 being disengaged and based in part on a seal 108 being released from the preloaded stress state.

In one example, the launch vehicle may be such that the capping system 100, 200 may be configured to close a vent line 502 when the launch vehicle is on a launch pad. The capping system 100, 200 may be configured to eject a cap 102 from a vent line 502 when the launch vehicle is in flight. For instance, a cap 102 may be configured to be ejected to enable venting to occur from the vent line 502 to prevent sideways thrust vectors for the launch vehicle. In another example, the cap 102 may be configured to be ejected based in part on a pressure within the propellant tank 510 or based in part on an altitude, location, or time of a flight for the launch vehicle. At least the altitude and location may be part of a flight sequence. The time may be also part of the flight sequence. In yet another example, the cap 102 may be associated with a vent line 502 of the propellant tank 510 such that the cap 102 can remain closed and any initial imbalance from venting through only one end of the vent line 502 may be countered by thrust and vectoring capabilities associated with the engine of the propulsion or rocket module of the launch vehicle. This may at least be the case until and/or just after a first stage separation. After stage separation, the cap may be configured to be ejected to cause venting from opposing sides of a vent line 502 and to prevent any subsequent imbalance from venting through only one end of the vent line 502.

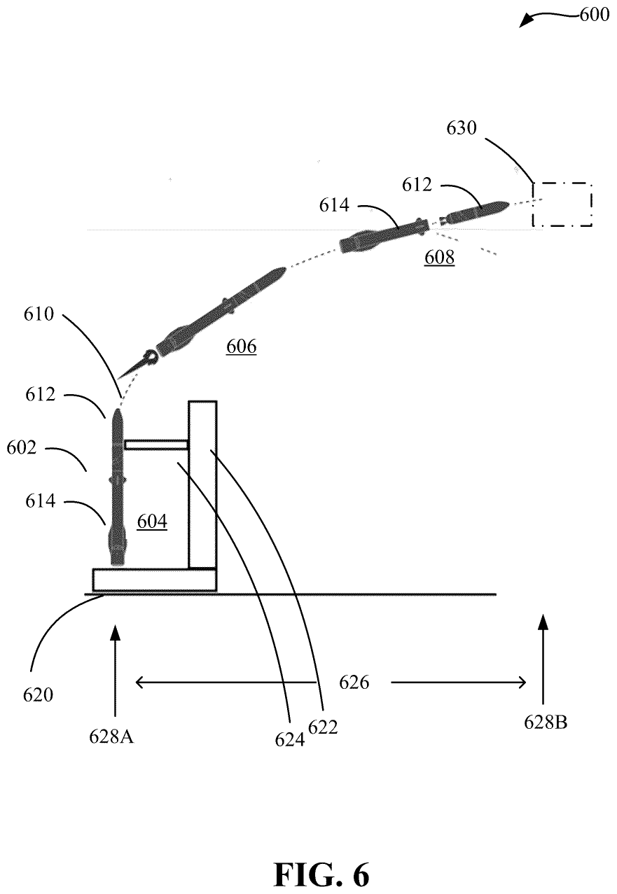

FIG. 6 illustrates part of space mission 600 for a launch vehicle having a capping system, in accordance with yet another non-limiting aspect of the present disclosure. The launch vehicle 602 may be intended for a flight sequence 604-608 of the space mission 600. The flight sequence 604-608 may be through a trajectory or flight path 610. The launch vehicle 602 may include at least one stage with a payload module 612 which may be atop of a propulsion module or rocket module 614, which may altogether represent the launch vehicle 602. The at least one stage may be an upper stage. The at least one stage with the payload module 612 may be associated with a propellant tank 510. The propulsion module or rocket module 614 may include an engine capable of addressing any initial imbalance, from venting of any pressure buildup in the propellant tank 510, through only one end of the vent line 502. For instance, the launch vehicle 602 may be able to use thrust and vectoring capabilities associated with the engine. Therefore, a capping system 100, 200 used with the launch vehicle 602 may have a cap that is closed for at least one end of the vent line 502 while the vehicle is on a launch pad 620, at a first part 604 of the flight sequence. Another end of the vent line 502 may vent any pressure build up, via an umbilical 624, to a flare stack 622.

Once the umbilical 624 is disconnected from the flare stack 622, the venting of a vent line 502 may continue as the launch vehicle proceeds 606 through a trajectory or flight path 610. The trajectory or flight path 610 may reflect an intended trajectory or flight path for a space mission. For instance, the trajectory or flight path 610 may be taken by each subsequent stage till a payload is delivered into orbit. After ascending through a time span 626, a stage separation 608 may occur, with the stage with the payload module 612 separating from the propulsion or rocket module 614. After the stage separation 608, in the absence of a powerful enough engine of the propulsion or rocket module 614 to provide the thrust and vectoring capabilities towards initial imbalance from venting through the first end of the vent line 502, the ejection of a cap 102 associated with a capping system 100, 200 on another end of the vent line 502 may be performed. The ejection of the cap 102 may enable a second venting to occur and to oppose the venting from the first end of the vent line 502. The second venting may be enabled by an opposing vent of the vent line and can prevent sideways thrust vectors for the launch vehicle 602.

In one example, an approximate area 630 may be a predetermined area that is clear of a trajectory or flight path 610 of the launch vehicle 602 or of a propulsion or rocket module 614 of the launch vehicle, following the stage separation 608. The predetermined area may provide a least or decreased possibility for the cap 102, after being ejected, from coming back into contact with any part of the launch vehicle 602, including the propulsion or rocket module 614, any fairings of the stage with the payload module 612, any other stages, or any payload from the stage with the payload module 612. Otherwise, the cap 102 could potentially cause damage to any part of the launch vehicle 602. The ability to not damage any part of the launch vehicle 602 enables a non-destructive, self-ejection of the cap 102, in at least one example, from the launch vehicle 602.

The approximate area 630 may be based in part on a time 628B from launch 628A and may be predetermined to represent a specific time window at which at least one cap 102, of a capping system 100, 200 in the launch vehicle 602, may be ejected. In addition, at the time 628B illustrated or at the approximate area 630, the stage with the payload module 612 may be in a predetermined position so that a cap 102 to be ejected may be directed, faced, or positioned for jettison away from trajectory or flight path intended for the stage with the payload module 612. For instance, a cap 102 may be directed to, faced towards, or positioned in a perpendicular direction with respect to the trajectory or flight path 610 initially associated with the launch vehicle 602. A cap 102 may be directed to, faced towards, or positioned in a perpendicular direction with respect to a different trajectory or flight path associated with the payload module. In addition, a release hinge 110 associated with a latch 118 for the cap 102 may be such that it is aft of the release mechanism 114 associated with the cap 102. This arrangement can also enable the cap 102 to be at a position so that the cap 102 may be facing or positioned for ejection away from trajectory or flight path of at least the stage with the payload module 612.

Therefore, in at least one example, when the capping system 100, 200 is used with a launch vehicle 602, one or more of the angles 202-206 of the release hinge 110 associated with the electrical fuse-based release mechanism 114 may be used, in part, to hold the seal 108 in the preloaded stress state and to hold the cap 102 closed against the interface panel 104 for a predetermined time 626 or sequence 604-608 of a space mission. Alternatively, or together with the predetermined time 626 or sequence 604-608 of the space mission, the cap 102 may be held closed against the interface panel 104 for a period based in part on an altitude or location of a flight for the launch vehicle 602.

In at least one example, based in part on pressures in a propellant tank 510, an altitude, or other setting associated with the propellant tank 510, the stage with the payload module 612, or with the propulsion or rocket module 614, it is possible to use the electrical circuit 410 to cause triggering of the release mechanism. For example, a signal along the provided electrical or circuit lines 412 can carry the electrical trigger to the fuse or fuse wire 408. The electric trigger to the fuse or fuse wire 408 can, in turn, cause a mechanical trigger (such as burning or disintegration) for the fuse wire. The mechanical trigger can cause the disengagement of the release mechanism 114. When the cap system is used with other applications, to ensure that an internal environment, within a space being closed, is retained from an external environment, the cap may be provided to be triggered for other purposes. For instance, in an imaging application, it is possible to have aspects of an imaging equipment protected by the cap until the imaging equipment is ready to be used or is in an obstruction-free or damage-free part of the external environment.

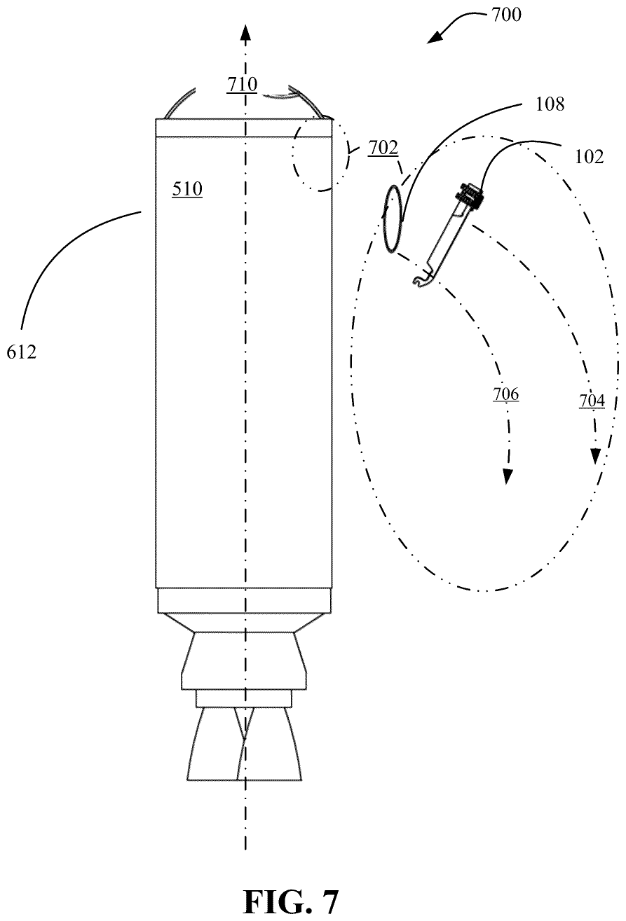

FIG. 7 illustrates aspects 700 associated with disengagement of caps to different trajectories or flight paths from a capping system in a launch vehicle, in accordance with yet another non-limiting aspect of the present disclosure. FIG. 7 illustrates that disengagement and deenergizing or releasing of a preloaded stress state in a seal 108 can cause, in part, separation or ejection 702 of a cap 102. There may be a predetermined combination of at least the preloaded stress state in the seal 108 to cause the cap 102 to diverge into a trajectory or flight path 704 that is different, relative to a trajectory or flight path 710 of the stage with the payload module 612 part of the launch vehicle 602, following stage separation 608. The seal 108 may also be ejected and separated from the cap 102. The seal 108 may follow a separate trajectory or flight path 706 that is different than the trajectory or flight path 710 of the stage with the payload module 612 or the trajectory or flight path 704 of the cap 102. The trajectory or flight path 710 of the stage with the payload module 612 may be along the trajectory or flight path 610 intended for the launch vehicle prior to stage separation 608.

In one example, the propulsion or rocket module 614 may diverge to return back to an area of the Earth's surface, while the stage (such as an upper stage) with the payload module 612 may continue its flight as part of the space mission 600. The trajectory or flight path 710 of the stage with the payload module 612 may be coincidental with the trajectory or flight path 610 of the launch vehicle, reflecting an intended trajectory or flight path for the space mission. In FIG. 7, the capping system may be associated with a venting system of the propellant tank 510 of the stage with the payload module 612. The cap 102 may be configured to be ejected based in part on a pressure within the propellant tank 510 or based in part on an altitude, location, or time of a flight for the launch vehicle 602. In one example, although stage separation has occurred, the separation or ejection 702 of the cap 102 from the stage with the payload module 612 is apparent as being from at least one component of the launch vehicle 602. The capping system may be such that at least a part of the capping system may be reusable for the launch vehicle 602. For instance, the interface panel 104 may remain with the launch vehicle but a cap 102 or seal 108 may be reused if captured by a different aspect of the space mission.

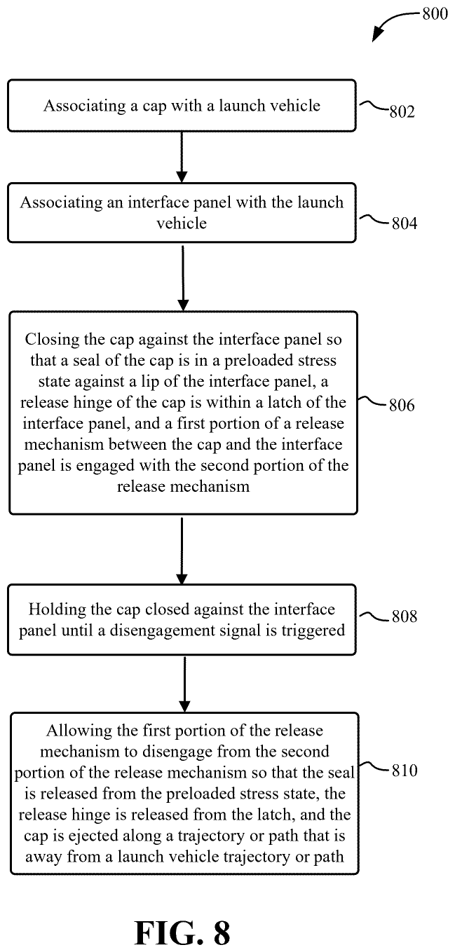

FIG. 8 illustrates a method 800 for a capping system, in accordance with yet another non-limiting aspect of the present disclosure. The method 800 may be part of a manufacture or an installation of the capping system for an application, including for a launch vehicle, as part of its preflight activities. The method 800 may include associating 802 a cap with a launch vehicle. The cap may include a seal, a release hinge, and a first portion of release mechanism. The method may include associating 804 an interface panel with the launch vehicle. The interface panel may include a lip, a latch, and a second portion of the release mechanism.

The method 800 may include closing 806 the cap against the interface panel. This may be so that the seal in the cap is in a preloaded stress state against the lip of the interface panel. The closing 806 step may also be so that the release hinge of the cap is within the latch of the interface panel. The closing 806 step may also be so that the first portion of the release mechanism that is within the cap is engaged with the second portion of the release mechanism that is within the interface panel. The method 800 may include holding 808 the cap closed against the interface panel until a disengagement signal is triggered.

In one example, the release mechanism may include an electrical fuse-based release mechanism used, in part, to hold the seal in the preloaded stress state and to hold the cap closed. A predetermined time or sequence of a space mission may be one basis to perform the disengagement in the holding 808 step. This predetermined time or sequence may be coded to a circuit to cause a trigger to the release mechanism. In another example, it may be possible to perform the disengagement by a trigger or instruction from an aspect having the circuit as part of the launch vehicle or from a remote location on the Earth's surface. Therefore, the closing 806 step may be so that the cap is enabled to be closed for the predetermined time or sequence. Then, it is possible to enable the disengagement of the first portion of the release mechanism from the second portion of the release mechanism during flight of the launch vehicle and after the predetermined or sequence has occurred.

The method 800 may include allowing 810 the first portion of the release mechanism to disengage from the second portion of the release mechanism. The allowing 810 step may be so that the seal is released from the preloaded stress state. The allowing 810 step may be so that the release hinge is released from the latch. The allowing 810 step may be so that the cap is ejected along a trajectory or path that is away from a launch vehicle trajectory or path.

The method 800 may include a step or sub-step for providing the engagement between the first portion of the release mechanism and the second portion of the release mechanism when the launch vehicle is in on a launchpad. In this step or sub-step, the cap may be closed on the launchpad. The method 800 may include a step or sub-step, as part of the allowing 810 step, for triggering the disengagement of the first portion of the release mechanism from the second portion of the release mechanism during flight of the launch vehicle.

The method 800 may be such that the release hinge is at a first angle with respect to the interface panel when the cap is closed. The method 800 may include a step or sub-step for causing, based on one or more of the disengagement of the release mechanism or the seal being released from the preloaded stress state, the release hinge to be at least at a second angle with respect to the interface panel to enable being ejected from the launch vehicle. The second angle may be caused as part of the allowing 810 step in the method 800.

The method 800 may be such that the seal is ejected along a different trajectory or path than the cap. The different trajectory or path may also be away from the launch vehicle trajectory or path. The method 800 may be such that the cap is configured to be ejected after stage separation of at least a payload module from a propulsion module during flight of the launch vehicle. The method 800 may be such that the cap is configured to be ejected based in part on a pressure within a propellant tank associated with launch vehicle or based in part on an altitude, location, or time of a flight for the launch vehicle. The method 800 may be such that at least a part of the cap or the interface panel is reusable for the launch vehicle.

The present disclosure has been described with reference to various exemplary and illustrative aspects. The aspects described herein are understood as providing illustrative features of varying detail of various aspects of the disclosed disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed disclosure. Accordingly, it will be recognized by persons having ordinary skill in the art that various substitutions, modifications or combinations of any of the exemplary aspects may be made without departing from the scope of the disclosure. In addition, persons skilled in the art will recognize, or be able to ascertain using no more than routine experimentation, many equivalents to the various aspects of the disclosure described herein upon review of this specification. Thus, the disclosure is not limited by the description of the various aspects, but rather by the claims.

What is claimed is:

1. A capping system for a launch vehicle, comprising:
a cap comprising a seal, a release hinge, and a first portion of release mechanism; and
an interface panel comprising a lip, a latch, and a second portion of the release mechanism,
wherein, when the cap is closed, the seal is in a preloaded stress state against the lip, the release hinge is within the latch, and the first portion of the release mechanism is engaged with the second portion of the release mechanism, and
wherein, when the first portion of the release mechanism is disengaged from the second portion of the release mechanism, the seal is released from the preloaded stress state, the release hinge is released from the latch, and the cap is ejected along a trajectory or path which is away from a launch vehicle trajectory or path.

2. The capping system of claim 1, wherein the capping system is associated with a venting system, and wherein the cap is associated with a vent line and is configured to be closed when the launch vehicle is in on a launchpad and is configured to be ejected during flight of the launch vehicle.

3. The capping system of claim 1, wherein the release hinge is at a first angle with respect to the interface panel when the cap is closed, and wherein the release hinge is at least at a second angle with respect to the interface panel to enable being ejected from the launch vehicle.

4. The capping system of claim 1, wherein second portion of the release mechanism comprises an electrical fuse-based release mechanism which is used, in part, to hold the seal in the preloaded stress state and to hold the cap closed, and wherein the cap is configured to be closed for a predetermined time or sequence of a space mission.

5. The capping system of claim 1, wherein the seal is ejected along a different trajectory or path than the cap, the different trajectory or path also being away from the launch vehicle trajectory or path.

6. The capping system of claim 1, wherein the capping system is associated with a venting system, and wherein the cap is configured to be ejected after stage separation of at least an upper stage from a propulsion module during flight of the launch vehicle.

7. The capping system of claim 1, wherein the capping system is associated with a venting system, and wherein the cap is configured to be ejected based in part on a pressure within a propellant tank associated with the venting system or based in part on an altitude, location, or time of a flight for the launch vehicle.

8. The capping system of claim 1, wherein at least a part of the capping system is reusable for the launch vehicle.

9. A launch vehicle comprising a propellant tank which is associated with a capping system, the capping system comprising a cap which is closed against an interface panel of the propellant tank by a release mechanism and by a seal under a preloaded stress state within the cap, wherein the cap is configured to be ejected along a trajectory or path which is away from a launch vehicle trajectory or path based in part on the release mechanism being disengaged and based in part on a seal being released from the preloaded stress state.

10. The launch vehicle of claim 9, wherein the capping system is configured to close a vent line and wherein the cap is configured to be ejected to enable venting to occur from the vent line to prevent sideways thrust vectors for the launch vehicle.

11. The launch vehicle of claim 9, wherein cap is associated with a vent line of the propellant tank and wherein the cap is configured to be closed when the launch vehicle is in on a launchpad and is configured to be ejected during flight of the launch vehicle.

12. The launch vehicle of claim 9, wherein the cap is configured to be ejected based in part on a pressure within the propellant tank or based in part on an altitude, location, or time of a flight for the launch vehicle.

13. A method associated with a capping system for a launch vehicle, comprising:
associating a cap with a launch vehicle, the cap comprising a seal, a release hinge, and a first portion of release mechanism;
associating an interface panel with the launch vehicle, the interface panel comprising a lip, a latch, and a second portion of the release mechanism;
closing the cap against the interface panel so that the seal is in a preloaded stress state against the lip, the release hinge is within the latch, and the first portion of the release mechanism is engaged with the second portion of the release mechanism; and
allowing the first portion of the release mechanism to disengage from the second portion of the release mechanism so that the seal is released from the preloaded stress state, the release hinge is released from the latch, and the cap is ejected along a trajectory or path which is away from a launch vehicle trajectory or path.

14. The method of claim 13, further comprising:
providing the engagement between the first portion of the release mechanism and the second portion of the release mechanism when the launch vehicle is in on a launchpad; and
triggering the disengagement of the first portion of the release mechanism from the second portion of the release mechanism during flight of the launch vehicle.

15. The method of claim 13, wherein the release hinge is at a first angle with respect to the interface panel when the cap is closed, and wherein the method further comprises:
causing, based on one or more of the disengagement of the release mechanism or the seal being released from the preloaded stress state, the release hinge to be at least at a second angle with respect to the interface panel to enable being ejected from the launch vehicle.

16. The method of claim 13, wherein the release mechanism comprises an electrical fuse-based release mechanism which is used, in part, to hold the seal in the preloaded stress state and to hold the cap closed, and wherein the method further comprises:
determining a predetermined time or sequence of a space mission;
enabling the cap to be closed for the predetermined time or sequence; and
enabling the disengagement of the first portion of the release mechanism from the second portion of the release mechanism during flight of the launch vehicle and after the predetermined or sequence has occurred.

17. The method of claim 13, wherein the seal is ejected along a different trajectory or path than the cap, the different trajectory or path also being away from the launch vehicle trajectory or path.

18. The method of claim 13, wherein the cap is configured to be ejected after stage separation of at least a payload module from a propulsion module during flight of the launch vehicle.

19. The method of claim 13, wherein the cap is configured to be ejected based in part on a pressure within a propellant tank associated with launch vehicle or based in part on an altitude, location, or time of a flight for the launch vehicle.

20. The method of claim 13, wherein at least a part of the cap or the interface panel is reusable for the launch vehicle.
